(19) United States
(12) Patent Application Publication
(10) Pub. No.: US 2024/0395142 A1
(43) Pub. Date: Nov. 28, 2024

(54) SENSOR MANAGEMENT OF REAL TIME MOVEMENTS TO PREDICT FUTURE MOVEMENTS

(71) Applicants: Amanda Reed, Springfield, MO (US); Daniel E. Reed, Springfield, MO (US)

(72) Inventors: Amanda Reed, Springfield, MO (US); Daniel E. Reed, Springfield, MO (US)

(21) Appl. No.: 18/732,313

(22) Filed: Jun. 3, 2024

Related U.S. Application Data
(63) Continuation-in-part of application No. 18/642,510, filed on Apr. 22, 2024.
(60) Provisional application No. 63/505,499, filed on Jun. 1, 2023.
(60) Provisional application No. 63/497,247, filed on Apr. 20, 2023.

(51) Int. Cl. G08G 1/0967; G01S 13/42; G01S 13/62; G01S 13/86; G01S 13/931

(52) U.S. Cl. CPC G08G 1/096766; G01S 13/42; G01S 13/62; G01S 13/867; G01S 13/931

(57) ABSTRACT

A predictive dynamic alert, control, and management system configured to simultaneously detect multiple moving and stationary entities in an environment. The system may use a combination of radio frequency ranging and local sensors to predict projected paths of environmental entities and bolster movement and positioning data in areas having low radio frequency bandwidth.

### CROSS-REFERENCE TO RELATED APPLICATIONS

This application claims the benefit of U.S. Provisional Application No. 63/505,499, filed Jun. 1, 2023. This application is also a continuation-in-part of U.S. application Ser. No. 18/642,510, filed Apr. 22, 2024, claiming priority from U.S. Provisional Application No. 63/497,247, filed Apr. 20, 2023. All of the foregoing patent disclosures are incorporated by this reference thereto.

### BACKGROUND OF THE INVENTION

The invention generally relates to the detection, movement, and control of multiple entities in an environment. Specifically, this invention relates to dynamically predicting, managing, and controlling moving entities in a congested or low signal strength environment.

High traffic high risk areas are filled with moving and stationary entities including but not limited to pedestrians, vehicles, and stationary infrastructure. Each moving entity runs the risk of collision with other moving and stationary entities in the environment.

Traditional entity location and warning systems rely on a plurality of sensors and transmitters to warn of potential entity collision. These systems typically include lidar for proximity sensing combined with the use of imaging devices to process surrounding entities that may be at issue. These systems also use GPS signals and cellular signals to calculate entity positioning on projected travel. These systems require high fidelity GPS and cellular signals to properly function and can be unreliable in low signal areas such as tunnels. In cases where signal is low, these systems may provide immediate warning or action to respective moving entities using the proximity sensing capabilities.

Proximity sensing on its own may be over-sensitive in highly congested environments where entities are designed to move in close proximity to each other such as the case in a logistics center or loading dock. Stopping moving entities unnecessarily causes a delay in work and productivity.

Cellular or Wi-Fi based systems often have to contact a back-end server and to process decisions and return decisions to the entity, the delay or possible lag in signal may cause be too late for the entity to make the proper decision.

Radio frequency based location tracking and management systems also run into issues of wireless bandwidth and signal strength management in congested environments as well as memory and processing management of each environmental entity.

The present invention attempts to remedy the shortcomings of the previous systems by providing a predictive dynamic alert, control, and management system.

### SUMMARY OF THE INVENTION

In light of the foregoing a predictive dynamic alert, control, and management system configured to detect moving and stationary entities, learn and predict traffic paths and traffic habits of entities, and provide advance warning and advance action to prevent collision, is provided.

In a first aspect of the invention, an environment comprises moving and stationary entities. Moving entities may include but are not limited to vehicles or machines while stationary entities may include but are not limited to stationary vehicles or machines or infrastructure or other stationary objects. At least one moving entity is coupled to or comprises a gateway computing device. The gateway computing device comprises a processor or controller and memory and is coupled to a sensor node. The sensor node comprises sensors to collect moving entity movement data and environmental entity movement or positional data. The sensor node communicates the collected data back to the gateway computing device to and the gateway computing device processes the data to determine if the moving entity needs to perform a secondary action.

In another aspect of system, a gateway computing device and sensor node is coupled to external environmental entities.

In yet another aspect of the system, each gateway computing device is communicatively coupled to each other in a single environment.

In another aspect of the system, the sensor node comprises a radio frequency (RF) transmitter and receiver configured for one-way or two-way ranging to detect other moving or stationary entities positions relative to the moving entity. The positional data is sent back to the moving entity gateway computing device to compute the environmental entity velocity and projected path. Each transmitter and receiver may be configured to transmit and receive over multiple bands and multiple channels. The RF transmitter and receiver may include but is not limited to Ultra-wideband (UWB), Bluetooth or Bluetooth Low Energy (BLE), Wi-Fi, or LoRa radios.

In an additional aspect of the system, additional object locating sensors or additional ranging radios may be integrated into the sensor node to improve the prediction and speed of session decision making. Additional sensors may be activated in cases of noisy or low fidelity RF signals or to save power or memory in processing location data from RF signals. Additional sensors may include but are not limited to proximity sensors, lidar sensors, or imagers.

The system may then perform sensor fusion by through its software by collating the collected and measured data from the multiple sensor nodes with different sensing technologies and transmit the collected and measured data to a system compute or prediction software node. The prediction node further uses the collated data to maintain a registry of all nearby entities, track their relative motion, and predict whether a collision is imminent. Further, the prediction node may form a distributed platform and continuously communicate with other prediction nodes in a peer-to-peer network, to ensure synchronization about the state of the environment. Further, the prediction nodes are configured to signal back to entities to notify and alert of any imminent collisions and implement any automated controls. The use of sensor fusion by collecting sensor node data of different types from different traffic members will act allow the system to see around visual blind spots not sensed by cameras or operator line of sight or allow the system to adapt when in cases of noisy RF signals, limited rf bandwidth environments or low memory/processing power in decoding RF signals.

It is to be recognized by one of skill in the art that the terms “software,” “app,” “module,” “routine,” or “sub-routine” may be used interchangeably in this specification to describe a software or component parts thereof. In some embodiments of the present invention, each described module or routine/sub-routine is a component part of a larger set of software instructions while in other embodiments each described module or routine/sub-routine act as independent software applications. It is also to be recognized by one of skill in the art that the term “database” as used may describe a single specific database, or a sub-section of a larger database.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 represents an operational environment.

FIG. 2 is a flow chart representing an embodiment of the operation of the system.

FIG. 3 is a flow chart representing an embodiment of the operation of the system.

FIG. 4 is a flow chart representing an embodiment of the operation of the system.

FIG. 5 is a flow chart representing an embodiment of the operation of the system.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

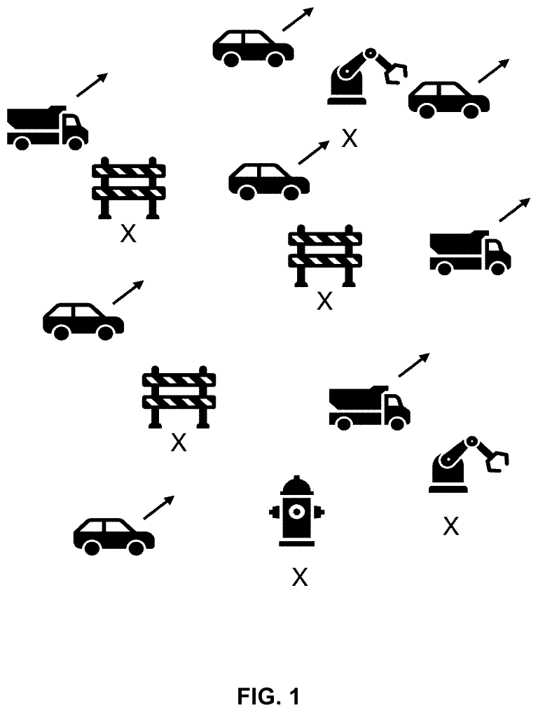

FIG. 1 represents an environment comprising moving entities represented by directional arrows and stationary entities represented by the letter “X” In a first aspect of the invention, an environment comprises moving and stationary entities. Moving entities may include but are not limited to vehicles or machines while stationary entities may include but are not limited to stationary vehicles or machines or infrastructure or other stationary objects. At least one moving entity is coupled to or comprises a gateway computing device.

The gateway computing device comprises a processor or microcontroller and memory and is coupled to a sensor node. The sensor node comprises sensors to collect moving entity movement data and environmental entity movement or positional data. To collect moving entity movement and positional data for example, the sensor node may include an accelerometer and/gyroscope. To collect external or environmental entity data, the sensor node may comprise an RF transmitter and receiver configured with a one-way or two-way ranging protocol. The sensor node communicates the collected data back to the gateway computing device and the gateway computing device processes the collected data to determine the moving entity velocity and projected path as well as each environmental entity velocity and projected path to determine if the moving entity needs to perform a secondary action. It should be recognized by one of skill in the art that the gateway computing device and sensor node may be separate components communicatively coupled, or a single integrated unit coupled to the moving entity, or a single or multiple units integrally coupled into the moving entity. It should also be recognized by one of skill in the art that the gateway computing device comprises software utilized by the processor or microcontroller to access the sensor node, collect and collate data, use such data to make predictive calculations, and transmit warning signals or operational controls to the coupled entity.

A gateway computing device may be coupled to each entity in the environment capable of movement or to stationary entities. In the case of permanently stationary entities, gateway computing devices may be configured to communicate its position to moving environmental entities and act as RF location beacons, or provide warning of potential co-location events based on the environmental moving entity's velocity and projected path.

In additional configurations, the gateway computing devices may be communicatively coupled to each other. Each gateway computing device may further comprise or be coupled to a means for wireless communication including but not limited to cellular, UWB, BT or BLE, Near field communication (NFC), Wi-Fi, LoRa, or other similar radios commonly used by one of skill in the art to communicate between two entities. Each gateway computing device may transmit its own velocity and projected path data to other environmental entities, or it may transmit pre-programmed entity identifiers to improve the other gateway device's ability to factor additional data into its predictive modeling.

For a moving entity to collect environmental entity movement and positional data locally, the sensor node may comprise a radio frequency (RF) transmitter and receiver configured for one-way or two-way ranging to detect other moving or stationary entities positions relative to the moving entity. The positional data is sent back to the moving entity gateway computing device to compute the environmental entity velocity and projected path. Each transmitter and receiver may be configured to transmit and receive over multiple bands and multiple channels. The RF transmitter and receiver may include but is not limited to Ultra-wideband (UWB), Bluetooth or Bluetooth Low Energy (BLE), Wi-Fi, or LoRa radios. One of skill in the art would recognize that one-way or two-way ranging are common operations in UWB and BLE specifications that rely on time of arrival or round trip time of transmitted signals.

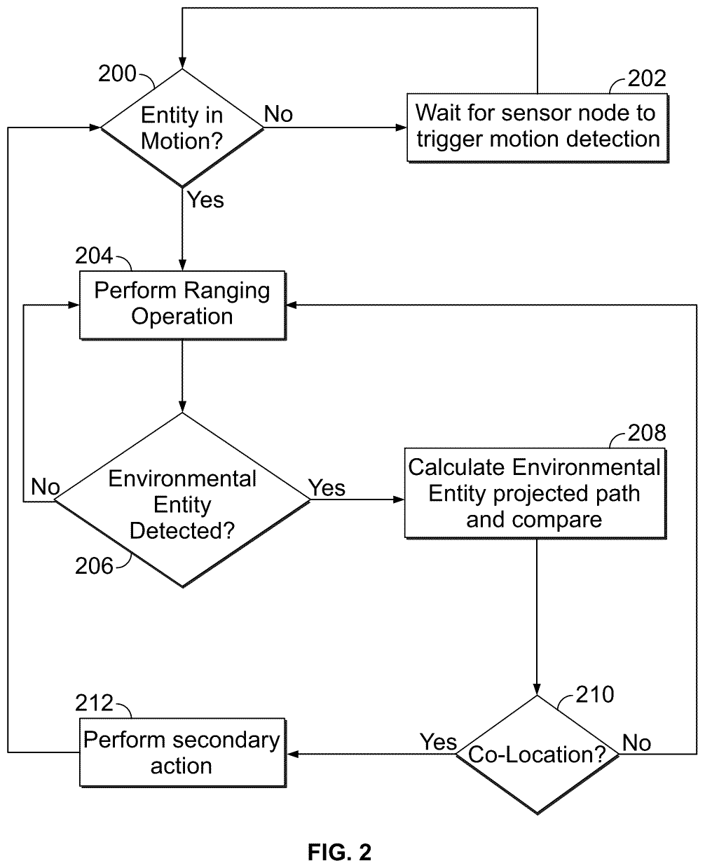

In basic operation, an example method of use is shown in FIG. 2 the gateway computing monitors its internal motion sensors to determine if its coupled entity is in motion 200. If the coupled entity is stationary, the gateway computing device may remain passive until it receives a motion signal from the sensor node 202. If the entity is moving, the gateway computing device performs a ranging operation 204 through the sensor node to detect environmental entities 206. If an environmental entity is detected, the gateway computing device will calculate the projected path of the of the environmental and compare the projected path with its own trajectory 208 and to determine a co-location event 210. If the gateway computing device does not predict a co-location event, the gateway computing device will continue to perform ranging the ranging operation 204, if the gateway computing device does predict a co-location event, the gateway computing device will perform a secondary action 212.

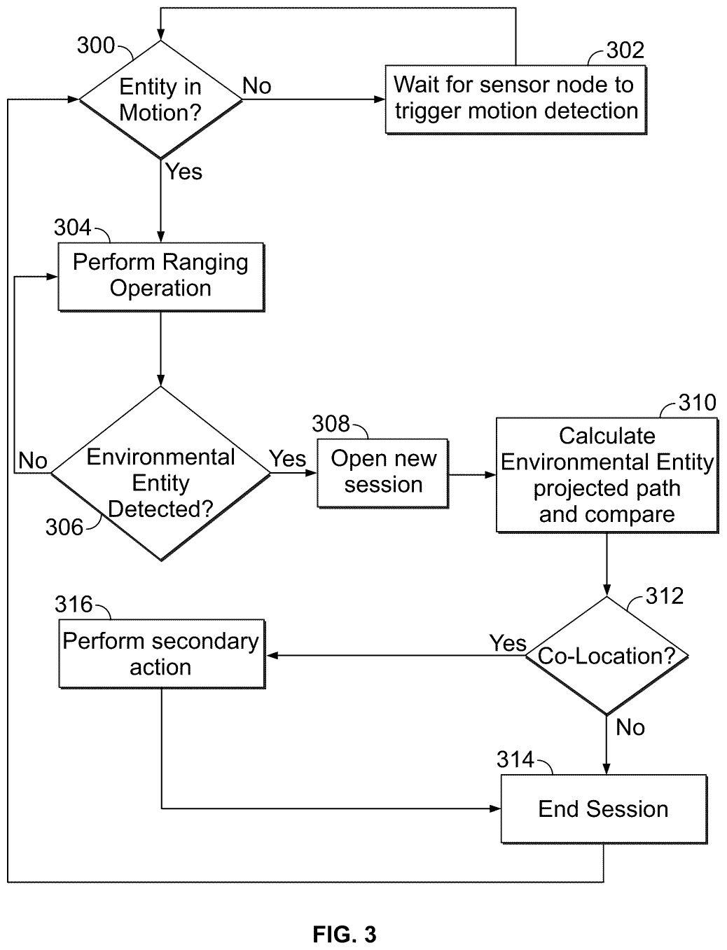

In more advanced operation, as shown in FIG. 3 the gateway computing monitors its internal motion sensors to determine if its coupled entity is in motion 300. If the coupled entity is stationary, the gateway computing device may remain passive until it receives a motion signal from the sensor node 302. If the entity is moving, the gateway computing device performs a ranging operation 304 through the sensor node to detect environmental entities 306. If an environmental entity is detected, the gateway computing device creates a new session in its memory for each environmental entity it detects 308. Sessions may be created simultaneously as multiple entities may be detected via ranging. In each session, the gateway computing device compares the moving entity velocity and projected path to the session entity velocity and projected path 310 and looks for a co-colocation event between entities 312. If no co-location event is detected, the session is ended 314 and the process repeats itself. If a co-location event is detected, the gateway computing device initiates a secondary action 316. The secondary action may include but is not limited to closing the session as the session entity is not on a projected path of co-location with the moving entity, sending a control signal to the moving entity to modify its velocity, or send an alert signal to the moving entity to warn an operator of a potential co-location/collision event. Other controls signals may include but are not limited to stopping or pausing or modifying operational actions of the moving entity such as adjusting direction, pathway, projection, angle, speed, plane, or other operations based on sensor detections within the defined space of the environment. A session can be ended as soon as a secondary action is completed and a new session formed upon a new detection or a redetection.

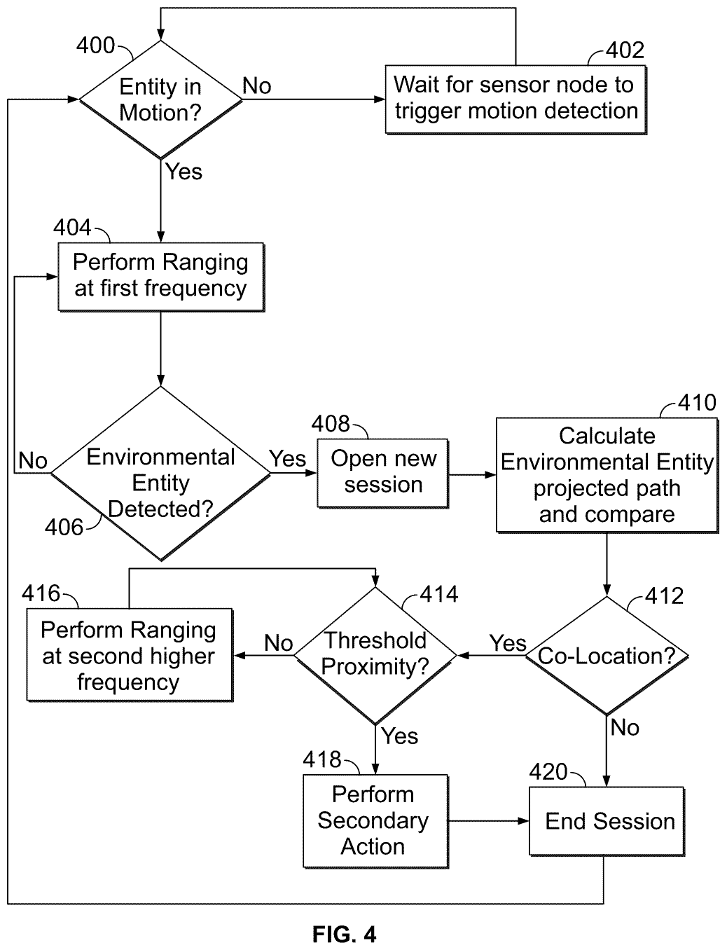

In additional operations, an example method of use is shown in FIG. 4, the gateway computing monitors its internal motion sensors to determine if its coupled entity is in motion 400. If the coupled entity is stationary, the gateway computing device may remain passive until it receives a motion signal from the sensor node 402. If the entity is moving, the gateway computing device performs a ranging operation 404 through the sensor node at a first frequency to detect environmental entities 406. If an environmental entity is detected, the gateway computing device creates a new session in its memory for each environmental entity it detects 408. Sessions may be created simultaneously as multiple entities may be detected via ranging. In each session, the gateway computing device compares the moving entity velocity and projected path to the session entity velocity and projected path 410 and looks for a co-colocation event between entities 412, but the entities are not in a pre-programmed proximity threshold to perform a secondary action 414, the gateway computing device may perform ranging at a second higher frequency to more accurately determine the environmental entity position and path 416. If no co-location event is detected, the session is ended 420 and the process repeats itself. If a co-location event is detected and within the pre-programmed proximity threshold to perform a secondary action, the gateway computing device performs the secondary action is performed 418. The secondary action may include but is not limited to closing the session as the session entity is not on a projected path of co-location with the moving entity, sending a control signal to the moving entity to modify its velocity, or send an alert signal to the moving entity to warn an operator of a potential co-location/collision event. Other controls signals may include but are not limited to stopping or pausing or modifying operational actions of the moving entity such as adjusting direction, pathway, projection, angle, speed, plane, or other operations based on sensor detections within the defined space of the environment. A session can be ended as soon as a secondary action is completed and a new session formed upon a new detection or a redetection.

The frequency of RF ranging may be increased or decreased depending on the session entity velocity and projected path. If the session entity is a lower threat based on the calculated velocity, projected path, and pre-programed variables such as entity path, entity time to slow/stop, or entity physical properties, the moving entity RF ranging may be conducted at a lower frequency, however, if the session entity is a high threat, the RF ranging may be increased to collect a greater number of data points and improve positional accuracy and projected path.

In an additional aspect of the system, additional object locating sensors or additional ranging radios may be integrated into the sensor node to improve the prediction and speed of session decision making. Additional sensors may be activated in cases of noisy or low fidelity RF signals or to save power or memory in processing location data from RF signals. It is an aspect of the invention to provide for sensor fusion of multiple technologies or detection methods to provide dynamic calculation of current or future actions, movement, and operation or intersection prediction. In this aspect, the gateway computing device will measure data from multiple sensor nodes comprising multiple sensor inputs. By way of example, a stationary traffic member sensor node coupled to and corresponding to an overhead beam may comprise an imager that records image and video data in its line of site. The video may be analyzed in the collate and prediction modules to recognize stationary and moving traffic members and develop a history of movement speeds and travel patterns to create a model of predicted future travel paths. In the same system and same environment an out of site traffic member may comprise UWB-proximity sensing that detects a traffic member moving closer and shares that measured proximity data through the collate module to the prediction module. The prediction module may then compare proximity data and historic path data to determine the likelihood of a collision. In the case where the data is from both sensors is frequently seen together and the paths never collide, the system may predict a collision is not imminent, however, in the case where the system has not learned or the data paths from both sensors in combination are likely to collide, the system can issue an alert or a control action to the respective traffic members through the sensor nodes.

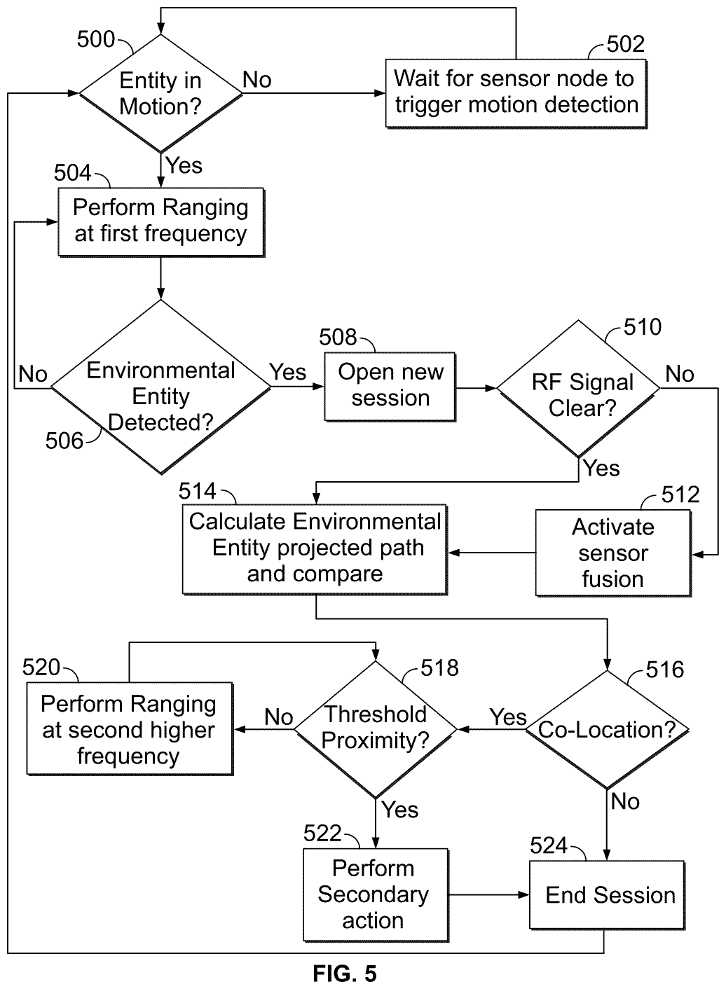

In operation, an example method of use is shown in FIG. 5, the gateway computing monitors its internal motion sensors to determine if its coupled entity is in motion 500. If the coupled entity is stationary, the gateway computing device may remain passive until it receives a motion signal from the sensor node 502. If the entity is moving, the gateway computing device performs a ranging operation 504 through the sensor node at a first frequency to detect environmental entities 506. If an environmental entity is detected, the gateway computing device creates a new session in its memory for each environmental entity it detects 508. Sessions may be created simultaneously as multiple entities may be detected via ranging. The gateway computing device looks for a clear ranging signal to perform its calculations 510, if the signal is too noisy or the gateway computing device does not have enough memory or power to process the signal, the gateway computing device may activate a secondary sensor as described in this specification to provide additional location data points to calculate 512. In each session, the gateway computing device compares the moving entity velocity and projected path to the session entity velocity and projected path 514 and looks for a co-colocation event between entities 516, but the entities are not in a pre-programmed proximity threshold to perform a secondary action 518, the gateway computing device may perform ranging at a second higher frequency to more accurately determine the environmental entity position and path 520. If no co-location event is detected, the session is ended 524 and the process repeats itself. If a co-location event is detected and within the pre-programmed proximity threshold to perform a secondary action, the gateway computing device performs the secondary action is performed 522. The secondary action may include but is not limited to closing the session as the session entity is not on a projected path of co-location with the moving entity, sending a control signal to the moving entity to modify its velocity, or send an alert signal to the moving entity to warn an operator of a potential co-location/collision event. Other controls signals may include but are not limited to stopping or pausing or modifying operational actions of the moving entity such as adjusting direction, pathway, projection, angle, speed, plane, or other operations based on sensor detections within the defined space of the environment. A session can be ended as soon as a secondary action is completed and a new session formed upon a new detection or a redetection.

One of skill in the art would recognize that the steps as shown in FIGS. 2-5 may be combined or reorganized to further optimize the management of sensor data collection.

In one example, the system comprises software modules that operate as follows:
Proximity—each entity will track all other entities that are in its proximity and use the RF signal strength from respective sensor nodes to determine if a respective entity should be tracked further. Each entity will maintain a ‘Proximity List’ that maintains the list of entities that are being tracked. The tracking may be conducted using:
Slow Two Way Ranging (TWR)—once an object is detected in the proximity range of an entity, it will start tracking the precise range of the object using a UWB-TWR at a relatively slow rate, in some cases this can be at 1 hz. Generally, TWR works by measuring the round trip time of a signal between a tag and an anchor, and then multiplying that time by the speed of light to calculate the distance between the two devices. Two sensor nodes will simultaneously range with the other traffic member to determine its relative bearing.
Fast TWR—a collate module of the system will use the Slow Ranging data to determine when an object can potentially be in the collision path. In case it determines that there is a risk, the other object will be added to a ‘Danger List’ and will switch to UWB-TWR at a relatively faster rate, for example, 10 Hz.
One Way Ranging (OWR)—the collate module will use the Slow Ranging data to determine if the traffic member has entered a Real Time Location Systems (RTLS) zone. If so, it will start UWB-OWR.
Accelerometer—each traffic member sensor node also collects 9-axis accelerometer data including gyroscope, magnetometer, and accelerometer.

After collection of tracking data as described above, each gateway computing device collates the data. The system collate module may operate as follows:
The collate layer runs on the each moving entity and uses sensor fusion or a combination of the respective sensor nodes to model the current state of the moving entity and environmental entity.

### First Moving Entity Collation:

Maintain Proximity List and Danger List
   The lists can include the following entities:
      Moving entities
      Stationary entities
   For each entity, maintain a history of the following:
      Range
      Ranging Mode (Slow-TWR, Fast-TWR or OWR)
The collate module will also model its own current state.
   Maintain a history of the 9-axis accelerometer readings.
   Use sensor fusion to estimate the following:
      Orientation
      Step Rate/Step Strength
      Activity State
         Still
         Moving
The current state will be wirelessly communicated to the other entity members.
The moving entity will determine if the environmental entity should be in the Danger List under the following conditions:
   If the environmental entity communicates that the moving entity is in its danger list
   If the environmental entity is headed towards them, and the range is less than a pre-programmed proximity threshold distance.

After this data is collated from the sensor fusion, the gateway computing device then uses a prediction module and models the future state of itself for each traffic member to determine if a collision/co-location is likely. In a first aspect, the gateway computing device will analyze the relative positioning collected from the UWB sensor and accelerometer to determine if traffic members are getting closer, the speed at which they are getting closer, and compare that to historical travel paths to predict likelihood of future collision. For example, with these assumptions, the algorithm will model the future state of the environmental entity and the other entity to determine if their bubbles will overlap.

It is an aspect of the invention to utilize relative calculated prediction information of any detected entities (identified and unidentified) within designated space to calculate prediction of movement or actions within area based on the entities, or combined entities, specific movement capabilities, specifications, patterns, operations, historical, or any other information to predict or control the interaction of detected entities including intersecting pathways, collisions, near-miss collisions, entity operations, operational responses, operational changes, operational status, malfunctions, signaling, alerts, data recording, data transfer or other uses.

It is an aspect of the invention to additionally provide for a system utilizing sensors or cameras for detection, recognition, classification, categorization, and/or identification of stationary or moving objects comprising: Detection of system entity/transponders; and/or detection of non-system entity/transponders, moving objects with recognition of identity markers for categorization of detected objects movement capabilities or other system controlled responses.

Those of ordinary skill in the art will understand and appreciate the aforementioned description of the invention has been made with reference to certain exemplary embodiments of the invention, which describe dynamic direction protocols, system, and method of use. Those of skill in the art will understand that obvious variations in construction, material, dimensions or properties may be made without departing from the scope of the invention which is intended to be limited only by the claims appended hereto.

1. A system to track real time movement of multiple entities in multiple simultaneous sessions comprising:
a plurality of gateway computing devices, each gateway computing device comprising a processor or controller, memory, each gateway computing device coupled to an entity of the multiple entities, wherein each gateway computing device is configured to send operational control commands or alert signals to each coupled entity of the multiple entities;
a plurality of sensor nodes, each sensor node of the plurality of sensor nodes communicatively coupled to or integrated into each gateway computing device, each sensor node of the plurality of sensor nodes configured to collect self-movement and positioning data through an accelerometer, collect external entity movement data through a radio frequency (RF) transmitter and receiver, and transmit the self-movement and positioning data and external entity movement data to the each coupled gateway computing device;
each gateway computing device configured to store and analyze the self-movement and positioning data and external entity movement data and create a projected future path of movement of a self-entity and plurality of external entities based on a dynamic and ongoing collection of the self-movement and positioning data and external entity movement data and history of prior collected or pre-programed movement data for each entity; and
each gateway computing device configured to compare the projected future path of the plurality of external entities to the projected future path of the self-entity to determine if the projected future path of the self-entity will intersect with the projected future path of the plurality of external entities.

2. The system of claim 1 wherein the gateway computing device is further configured to communicate a projected intersection to the self-entity causing the self-entity to perform a secondary action.

3. The system of claim 2 wherein the secondary action is an alert to the self-entity of the projected intersection or a control signal causing the self-entity to change its projected path.

4. The system of claim 1 wherein the RF transmitter and receiver is an ultra-wideband (UWB) transmitter and receiver or Bluetooth Low Energy (BLE) transmitter and receiver.

5. The system of claim 1 wherein the RF transmitter and receiver is configured for one-way or two-way ranging wherein the RF transmitter and receiver transmit the ranging signal to the gateway computing device to calculate the external entity movement data.

6. The system of claim 5 wherein each gateway computing device creates a simultaneous tracking session for each detected external entity.

7. The system of claim 6 wherein each simultaneous tracking session comprises a projected future path of the session external entity.

8. The system of claim 7 wherein the gateway computing device is configured to initiate one-way or two-way ranging at an increased frequency when the session external entity reaches a pre-programmed projected path proximity threshold and reduce the one-way or two-way ranging frequency when the session external entity is outside of the pre-programmed projected path proximity threshold.

9. The system of claim 8 wherein the pre-programmed projected path proximity threshold is determined using at least one of the following factors: session entity projected path, session entity speed, session entity orientation, or session entity historical paths.

10. The system of claim 8 wherein each gateway computing device is configured receive session external entity movement data from an environmental sensor or an additional sensor coupled to the session external entity.

11. The system of claim 10 wherein the gateway computing device is configured to request and receive accelerometer data from the session external entity and integrate the accelerometer data into session external entity projected path calculation.

12. The system of claim 10 wherein the gateway computing device is configured to request and receive video data from an environmental camera of the session external entity and integrate the video data into a session external entity projected path calculation.

13. The system of claim 10 wherein each gateway computing device seeks additional sensor data from the environmental sensor or additional sensor coupled to the session external entity when the ranging signal is of low integrity.

14. The system of claim 10 wherein each gateway computing device seeks additional sensor data from the environmental sensor or additional sensor coupled to the session external entity when the gateway computing device is in a low power state or a low memory state.

15. A system to track real time movement of multiple entities in multiple simultaneous sessions comprising:
at least one gateway computing device, the at least one gateway computing device comprising a processor or controller, memory, the at least one gateway computing device coupled to a moving entity of the multiple entities, wherein the at least one gateway computing device is configured to send operational control commands or alert signals to the moving entity;
at least one sensor node, the at least one sensor node communicatively coupled to or integrated into the at least one gateway computing device, the at least one sensor configured to collect self-movement and positioning data through an accelerometer, collect external entity positioning data through a radio frequency (RF) transmitter and receiver, and transmit the self-movement and positioning data and external entity positioning data to the at least one gateway computing device;
the at least one gateway computing device configured to store and analyze the self-movement and positioning data and external entity positioning data and create a projected future path of movement of the moving entity based on a dynamic and ongoing collection of the self-movement and positioning data and external entity position data and history of prior collected or pre-programed positioning data for each external entity; and
the at least one gateway computing device configured to compare the projected future path of the moving entity to the external positioning data to determine if the projected path of the moving entity will intersect with a position of an external entity.

16. The system of claim 15 wherein the gateway computing device is further configured to communicate a projected intersection to the moving entity causing the at least one gateway computing device to perform a secondary action.

17. The system of claim 16 wherein the secondary action is an alert to the moving entity of the projected intersection or an operational control command signal causing the moving entity to change its projected path.

18. The system of claim 15 wherein the RF transmitter and receiver is an ultra-wideband (UWB) transmitter and receiver or Bluetooth Low Energy (BLE) transmitter and receiver.

19. The system of claim 15 wherein the RF transmitter and receiver is configured for one-way or two-way ranging wherein the RF transmitter and receiver transmit the ranging signal to the gateway computing device to calculate the external entity movement data.

20. The system of claim 19 wherein the at least one gateway computing device creates a simultaneous tracking session for each detected external entity.

21. The system of claim 20 wherein each simultaneous tracking session comprises external positioning data of the session external entity.

22. The system of claim 21 wherein the gateway computing device is configured to initiate one-way or two-way ranging at an increased frequency when the session external entity reaches a pre-programmed projected path proximity threshold and reduce the one-way or two-way ranging frequency when the session external entity is outside of the pre-programmed projected path proximity threshold.

23. The system of claim 22 wherein the pre-programmed projected path proximity threshold is determined using at least one of the following factors: session entity projected path, session entity speed, session entity orientation, or session entity historical paths.

24. The system of claim 19 wherein the at least one gateway computing device is configured receive session external entity positioning data from an environmental sensor or an additional sensor coupled to the session external entity.

25. The system of claim 24 wherein the at least one gateway computing device is configured to request and receive video data from an environmental camera of the session external entity and integrate the video data into the session external entity positioning data.

26. The system of claim 24 wherein the at least one gateway computing device seeks additional sensor data from the environmental sensor or additional sensor coupled to the session external entity when the ranging signal is of low integrity.

27. The system of claim 24 wherein the at least one gateway computing device seeks additional sensor data from the environmental sensor or additional sensor coupled to the session external entity when the gateway computing device is in a low power state or a low memory state.

28. A system to track real time movement of multiple entities in multiple simultaneous sessions comprising:
a first moving entity and at least a stationary entity or at least a second moving entity;
the first moving entity coupled to a first gateway computing device, the gateway computing device comprising a processor or controller and memory;
a sensor node communicatively coupled to or integrated into the first gateway computing device, the sensor node configured to collect first moving entity movement and positioning data and collect second moving entity movement data or stationary entity positioning data through a radio frequency (RF) transmitter and receiver, and transmit the first moving entity movement and positioning data and second moving entity movement data or stationary entity positioning data to the gateway computing device;
the first gateway computing device configured to store and analyze the first moving entity movement and positioning data and determine first moving entity velocity, first moving entity stop time, and projected co-location of the first moving entity and the second moving entity or stationary entity; and
the first gateway computing device further configured to transmit operational control commands or alert signals to the moving entity in a projected co-location of first moving entity and the second moving entity or stationary entity.

29. The system of claim 28 wherein:
the stationary entity is coupled to a stationary gateway computing device;
a stationary sensor node is communicatively coupled to or integrated into the stationary gateway computing device, the stationary sensor node configured to stationary positioning data and collect first moving entity movement data or second entity movement data through a radio frequency (RF) transmitter and receiver, and transmit the first moving entity movement data or second entity movement data to the stationary gateway computing device;
the stationary gateway computing device is configured to store and the first moving entity movement data or second entity movement data and determine first moving entity or second moving entity velocity, determine first moving entity or second moving, determine first moving entity or second moving entity stop time, and projected co-location of the first moving entity or the second moving entity with stationary entity; and
the stationary gateway computing device is further configured to transmit operational control commands or alert signals to the first moving entity or second moving entity in a projected co-location event of first moving entity or the second moving entity and the stationary entity.

30. The system of claim 29 wherein the first gateway computing device and the stationary gateway computing device are communicatively coupled.

31. The system of claim 28 wherein:
the second moving entity is coupled to a second gateway computing device;
a second sensor node is communicatively coupled to or integrated into the second gateway computing device, the second sensor node configured to collect second moving entity movement and positioning and collect first moving entity movement data or stationary entity positioning data through a radio frequency (RF) transmitter and receiver, and transmit the second moving entity movement and positioning data and first moving entity movement data or stationary entity positioning data to the second gateway computing device;
the second gateway computing device is configured to store and analyze the second moving entity movement and positioning data and determine second moving entity velocity, second moving entity stop time, and projected co-location of the first moving entity and the second moving entity or stationary entity; and
the gateway computing device is further configured to transmit operational control commands or alert signals to the second moving entity in a projected co-location event of first moving entity and the second moving entity or stationary entity.

32. The system of claim 31 wherein the first gateway computing device and the second gateway computing device are communicatively coupled.

33. The system of claim 31 wherein each gateway computing device creates a movement management session for each detected moving entity or stationary entity and each movement management session results in each gateway computing device initiating a secondary action for each coupled entity.

34. The system of claim 33 wherein the secondary action comprises an operational control command or an alert.

35. The system of claim 34 where an operational control command comprises a change in velocity for the coupled moving entity.

36. The system of claim 33 wherein a subsequent movement management session is created after the secondary action is performed.

37. The system of claim 33 wherein a subsequent movement management session is created after the secondary action is performed if the coupled entity is still moving.

38. The system of claim 33 wherein each RF transmitter and receiver is an ultra-wideband (UWB) transmitter and receiver or a Bluetooth Low Energy (BLE) transmitter and receiver.

39. The system of claim 33 wherein each RF transmitter and receiver is configured for one-way or two-way ranging wherein each RF transmitter and receiver transmit the ranging signal to each gateway computing device to calculate external entity movement data.

40. The system of claim 39 wherein each gateway computing device is configured to initiate one-way or two-way ranging at an increased frequency when the session entity reaches a pre-programmed projected path proximity threshold and reduce the one-way or two-way ranging frequency when the session entity is outside of the pre-programmed projected path proximity threshold.

41. The system of claim 40 wherein the pre-programmed projected path proximity threshold is determined using at least one of the following factors: session entity projected path, session entity speed, session entity orientation, or session entity historical paths.

42. The system of claim 39 wherein at least one gateway computing device is configured to receive session external entity positioning data from an environmental sensor or an additional sensor coupled to the session entity.

43. The system of claim 42 wherein the at least the first gateway computing device is configured to request and receive video data from an environmental camera of the session entity and integrate the video data into the session entity positioning data.

44. The system of claim 42 wherein at least one gateway computing device seeks additional sensor data from the environmental sensor or additional sensor or RF transmitter and receiver coupled to the session external entity when the ranging signal is of low integrity.

45. The system of claim 42 wherein at least one gateway computing device seeks additional sensor data from the environmental sensor or additional sensor or RF transmitter and receiver coupled to the session entity when the at least one gateway computing device is in a low power state or a low memory state.
